(19) United States
(12) Patent Application Publication
(10) Pub. No.: US 2017/0060068 A1
(43) Pub. Date: Mar. 2, 2017

(54) IMAGE FORMING APPARATUS

(71) Applicant: KYOCERA Document Solutions Inc., Osaka (JP)

(72) Inventor: Toshio HORI, Osaka-shi (JP)

(73) Assignee: KYOCERA Document Solutions Inc., Osaka (JP)

(21) Appl. No.: 15/237,002

(22) Filed: Aug. 15, 2016

(30) Foreign Application Priority Data
Aug. 28, 2015 (JP) 2015-169570

(51) Int. Cl. G03G 15/00

(52) U.S. Cl. CPC G03G 15/6579

(57) ABSTRACT

An image forming apparatus includes a duplex conveying unit, an intermediate conveying unit, a duplex conveying path, a main conveying path and a locking mechanism. The duplex conveying unit turnable around its lower end is provided in an aperture of an apparatus main body. The intermediate conveying unit turnable around its lower end is disposed inside the duplex conveying unit. The duplex conveying path is arranged between the duplex conveying unit and the intermediate conveying unit. The main conveying path is arranged inside the intermediate conveying unit. The locking mechanism couples the duplex conveying unit and the intermediate conveying unit by turning the duplex conveying unit and the intermediate conveying unit in an approaching direction to each other. The locking mechanism decouples the duplex conveying unit and the intermediate conveying unit by turning the duplex conveying unit and the intermediate conveying unit in a separating direction from each other.

### INCORPORATION BY REFERENCE

This application is based on and claims the benefit of priority from Japanese Patent application No. 2015-169570 filed on Aug. 28, 2015, the entire contents of which are incorporated herein by reference.

### BACKGROUND

The present disclosure relates to an image forming apparatus which includes a conveying unit arranging a conveying path.

In an image forming apparatus, such as a copying machine or a printer, a sheet is conveyed along a conveying path, such as a main conveying path running from a sheet feeding cartridge toward an image forming part or a duplex conveying path in which a top and a bottom of the sheet are reversed in order to carry out duplex printing. Such a conveying path is configured so as to be openable in order to easily deal with a sheet jam even in a case where the sheet jam occurs in the conveying path.

The image forming apparatus provided with the main conveying path and the duplex conveying path includes a duplex conveying unit provided in an aperture of an apparatus main body to be turnable around a lower end and an intermediate conveying unit disposed inside of the duplex conveying unit to be turnable around a lower end. Between the duplex conveying unit and the intermediate conveying unit, the duplex conveying path is arranged and, inside of the intermediate conveying unit, the main conveying path is arranged. In addition, the duplex conveying path is opened by turning the duplex conveying unit and the main conveying path is opened by turning the intermediate conveying unit.

In addition, the intermediate conveying unit and the duplex conveying unit may be provided to be integrally turnable for the sake of increasing efficiency of the work of dealing with the sheet jam. For example, there is an image forming apparatus including a coupling and decoupling mechanism capable of coupling and decoupling the intermediate conveying unit and the duplex conveying unit. In this image forming apparatus, the intermediate conveying unit and the duplex conveying unit are supported to be turnable around respective supporting shafts provided at different heights. By utilizing a difference between turning radiuses of both units, if a turning angle of the duplex conveying unit is increased, coupling is automatically released.

However, in the image forming apparatus mentioned above, because it is necessary to keep the height of the supporting shaft of the intermediate conveying unit and the height of the supporting shaft of the duplex conveying unit apart from each other at a predetermined distance, there is a problem that the image forming apparatus is enlarged. The image forming apparatus also may be configured so that the duplex conveying unit is provided with a lever and the intermediate conveying unit is held by the lever. However, in such a case, because the work of releasing the lever or the like is required when only the intermediate conveying unit is independently turned, the workability is impaired.

### SUMMARY

In accordance with an embodiment of the present disclosure, an image forming apparatus includes a duplex conveying unit, an intermediate conveying unit, a duplex conveying path, a main conveying path and a locking mechanism. The duplex conveying unit is provided in an aperture of an apparatus main body to be turnable around a lower end thereof. The intermediate conveying unit is disposed inside the duplex conveying unit and provided to be turnable around a lower end thereof. The duplex conveying path is arranged between the duplex conveying unit and the intermediate conveying unit. The main conveying path is arranged inside the intermediate conveying unit. The locking mechanism couples the duplex conveying unit and the intermediate conveying unit to each other by turning the duplex conveying unit and the intermediate conveying unit in an approaching direction to each other. The locking mechanism also decouples the duplex conveying unit and the intermediate conveying unit from each other by turning the duplex conveying unit and the intermediate conveying unit in a separating direction from each other.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view schematically showing an internal structure of a color printer according to an embodiment of the present disclosure.

FIG. 2 is a perspective view showing a duplex conveying unit and an intermediate conveying unit in the color printer according to the embodiment of the present disclosure.

FIG. 3 is a side view showing the duplex conveying unit and the intermediate conveying unit coupled to each other in the color printer according to the embodiment of the present disclosure.

FIG. 4 is a side view showing the duplex conveying unit and the intermediate conveying unit decoupled from each other in the color printer according to the embodiment of the present disclosure.

FIG. 5 is a perspective view showing a locking mechanism between the duplex conveying unit and the intermediate conveying unit in the color printer according to the embodiment of the present disclosure.

FIG. 6 is a sectional view showing a stopper of the locking mechanism in the color printer according to the embodiment of the present disclosure.

FIG. 7 is a sectional perspective view showing the locking mechanism between the duplex conveying unit and the intermediate conveying unit in a state that the stopper is advanced and fitted into a depression in the color printer according to the embodiment of the present disclosure.

FIG. 8 is a sectional perspective view showing the locking mechanism between the duplex conveying unit and the intermediate conveying unit in a state that the stopper is retracted and disengaged from the depression in the color printer according to the embodiment of the present disclosure.

FIG. 9 is a sectional perspective view showing the locking mechanism between the duplex conveying unit and the intermediate conveying unit in a state that the stopper is advanced in the color printer according to the embodiment of the present disclosure.

### DETAILED DESCRIPTION

In the following, with reference to the drawings, an image forming apparatus according to an embodiment of the present disclosure will be described.

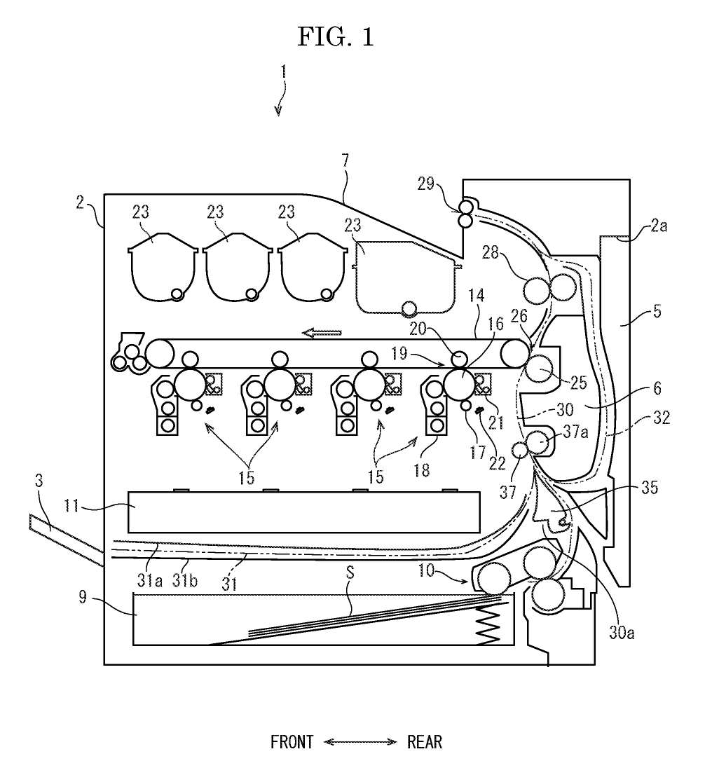

First, with reference to FIG. 1, entire structure of a color printer 1 as the image forming apparatus according to the embodiment of the present disclosure will be described. FIG. 1 is a sectional view schematically showing an internal structure of the color printer. Incidentally, hereinafter, it will be described so that the front side of the color printer 1 is positioned at a left side of FIG. 1 and that left and right directions is defined as seen from the front side of the color printer 1.

The color printer 1 includes, as shown in FIG. 1, a box-shaped apparatus main body 2. On a front face of the apparatus main body 2, a manual bypass tray 3 is provided and, on a rear face thereof, an aperture 2a is formed. The aperture 2a is opened and closed by a duplex conveying unit 5 supported to be turnable around a lower end thereof. Inside of the duplex conveying unit 5, an intermediate conveying unit 6 is supported to be turnable around a lower end thereof. The duplex conveying unit 5 and the intermediate conveying unit 6 will be described later. Further, on an upper face of a top cover covering a top face of the apparatus main body 2, an ejected sheet tray 7 onto which a sheet is ejected is formed.

At a lower part of the apparatus main body 2, a sheet feeding cartridge 9 in which a sheet S is stored is attachably/detachably provided and, at a rear side of the sheet feeding cartridge 9, a sheet feeding device 10 feeding the sheet from the sheet feeding cartridge 9 is provided. at an upper side of the sheet feeding cartridge 9, an exposure device 11 composed of a laser scanning unit (LSU) is provided and, at an upper side of the exposure device 11, an intermediate transferring belt 14 as an image carrier is rotatably supported. Along a lower part of the intermediate transferring belt 14, four image forming parts 15 disposed for the respective colors of toners are provided.

In each image forming part 15, a photosensitive drum 16 is rotatably provided and, around the photosensitive drum 16, a charging device 17, a development device 18, a primary transferring roller 20 composing a primary transferring part 19 with an intermediate transferring belt 14, a cleaning device 21, and a static eliminator 22 are disposed in sequential order of primary transferring process. At an upper side of the intermediate transferring belt 14, four toner containers 23 corresponding to the respective image forming parts 15 are installed for the respective colors of the toners (Y, M, C, K).

In addition, at a rear side of the intermediate transferring belt 14, a secondary transferring roller 25 is rotatably supported on the intermediate conveying unit 6 and, between the intermediate transferring belt 14 and the secondary transferring roller 25, a secondary transferring part 26 is arranged. At an upper side of the secondary transferring part 26, a fixing device 28 is provided and, at an uppers side of the fixing device 28, a sheet ejecting part 29 facing to the ejected sheet tray 7 is provided.

Inside of the apparatus main body 2, a main conveying path 30 from the sheet feeding device 10 toward the sheet ejecting part 29 through the secondary transferring part 26 and the fixing device 28 is provided. The main conveying path 30 between the sheet feeding device 10 and the fixing device 28 is arranged on a front side of the intermediate conveying unit 6. In the main conveying path 30, a manual bypass conveying path 31 extending from the manual bypass tray 3 joins a joining part 30a at a downstream side from the sheet feeding device 10. The manual bypass conveying path 31 is composed of an upper guiding plate 31a and a lower guiding plate 31b arranged in upward and downward directions in parallel to face to each other at a predetermined interval. Further, in the main conveying path 30, a duplex conveying path 32 for duplex printing also joins the joining part 30a. The duplex conveying path 32 is branched from the main conveying path 30 to a back face side at a downstream side from the fixing device 28 and arranged with a C-shaped cross section. The duplex conveying path 32 is arranged between a rear side face of the intermediate conveying unit 6 and a front side face of the duplex conveying unit 5. At the joining part 30a, an intermediate guide 35 is disposed.

In the main conveying path 30, at the downstream side from the joining part 30a, a pair of resist rollers 37 are provided. One roller 37a of the pair of resist rollers 37 is supported on the intermediate conveying unit 6.

Next, an image forming operation of the color printer 1 having such configuration will be described. In each image forming part 15, after a surface of the photosensitive drum 16 has been electrically charged by the charging device 17, exposure corresponding to image data is carried out with respect to the photosensitive drum 16 by laser light from the exposure device 11 and an electrostatic latent image is formed on the surface of the photosensitive drum 16. The electrostatic latent image is developed as a toner image of a corresponding color by the development device 18 and the toner image is primarily transferred onto the surface of the intermediate transferring belt 14 in the primary transferring part 19. the above-described operation is sequentially repeated by the respective image forming parts 15 and a full-color toner image is thereby formed on the intermediate transferring belt 14. Incidentally, the toner and electric charge having remained on the photosensitive drum 16 are removed by the cleaning device 21 and the static eliminator 22.

On the other hand, the sheet having been fed out from the sheet feeding cartridge 9 by the sheet feeding device 10 is conveyed to the secondary transferring part along the main conveying path 30 at a synchronized timing with the image forming operation described above and, in the secondary transferring part 26, the full-color toner image on the intermediate transferring belt 14 is secondarily transferred onto the sheet. The sheet onto which the toner image has been secondarily transferred is conveyed to the downstream side in the main conveying path 30 and advanced to the fixing device 28, and then, in the fixing device 28, the toner image is fixed onto the sheet. The sheet onto which the toner image has been fixed is ejected from the sheet ejecting part 29 to the ejected sheet tray 7.

In addition, the sheet having been conveyed from the manual bypass tray 3 along the manual bypass conveying path 31 is guided to the main conveying path 30 at the joining part 30 by the intermediate guide 35, and then, the image forming operation is carried out similarly. In a case where duplex printing is carried out, the sheet with an image being formed onto one face thereof is conveyed to the joining part 30a through the duplex conveying path 32 and guided to the main conveying path 30 at the joining part 30a by the intermediate guide 35, and then, the image forming operation is carried out similarly.

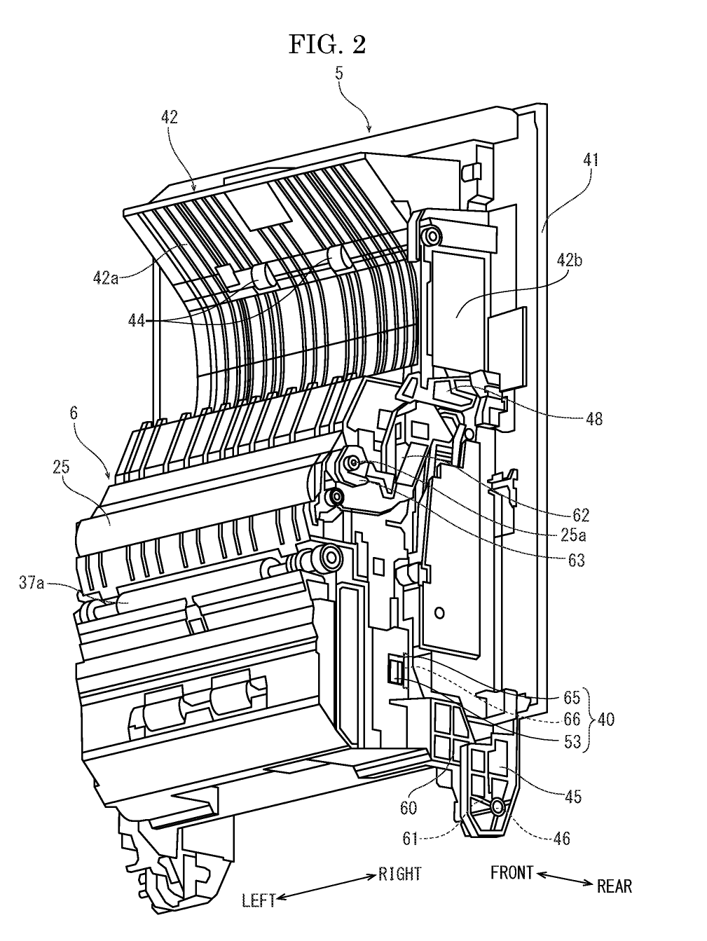

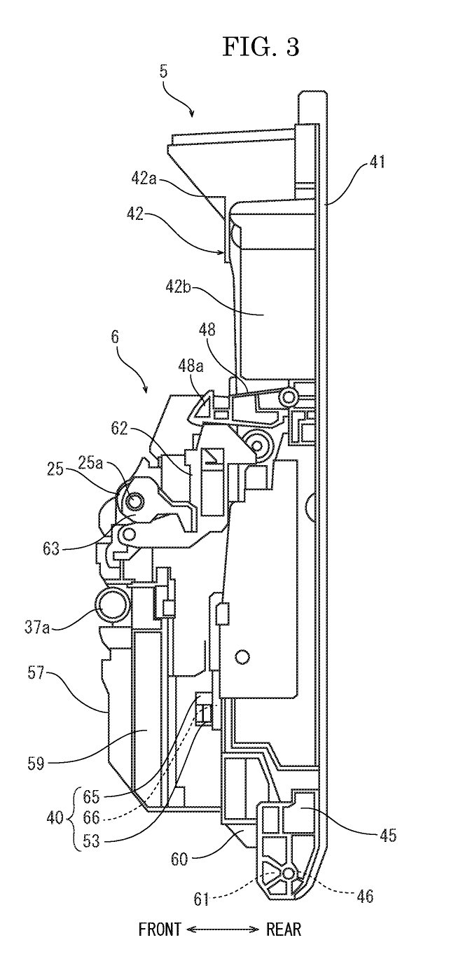

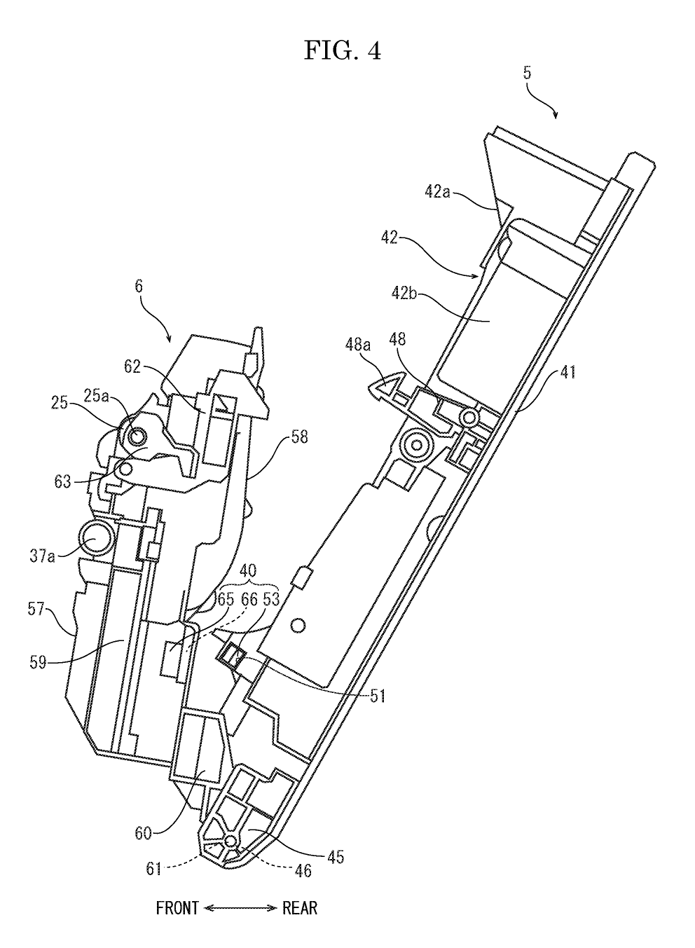

Next, with reference to FIG. 2 to FIG. 4, the duplex conveying unit 5 and the intermediate conveying unit 6 will be described. FIG. 2 is a perspective view showing the duplex conveying unit and the intermediate conveying unit, FIG. 3 is a side view showing the duplex conveying unit and the intermediate conveying unit coupled to each other and FIG. 4 is a side view showing the duplex conveying unit and the intermediate conveying unit decoupled from each other.

As described above, the duplex conveying unit 5 is provided in the aperture 2a of the apparatus main body 2, and the intermediate conveying unit 6 is provided inside of the duplex conveying unit 5. The duplex conveying unit 5 and the intermediate conveying unit 6 are provided with a locking mechanism 40 coupling both units 5 and 6 to each other by turning both units 5 and 6 in an approaching direction to each other and decoupling both units 5 and 6 from each other by turning both units 5 and 6 in a separating direction from each other.

First, the duplex conveying unit 5 will be described. The duplex conveying unit 5 includes a cover plate 41 covering the aperture 2a of the apparatus main body 2 and a guiding part 42 provided on a front face of the covering plate 41.

A front face 42a of the guiding part 42 curves in a substantial C-shape as viewed from the lateral side, has a plurality of ribs formed along the upward and downward direction and has conveying rollers 44 rotatably supported at predetermined intervals. In addition, on left and right side faces 42b of the guiding part 42, arm pieces 45 protruding downwardly from its lower edge are extended. At lower ends of the respective arm pieces 45, supporting shafts 46 are coaxially formed. Each supporting shaft 46 is pivoted to a pivoting part (not shown) formed inside of the aperture 2a, and thereby, the duplex conveying unit 5 turns around the supporting shaft 46 between a closed position at which the aperture 2a is closed and an open position at which the aperture 2a is opened.

Further, on left and right side faces 42b of the guiding part 42, opening and closing levers 48 for engaging with and disengaging from the apparatus main body 2 are supported at respective positions at slightly upper side positions from a center in a height direction. In each opening and closing lever 48, a claw part 48a protruding upwardly is formed at a distal end thereof and the claw part 48a is supported by an elastic member (not shown) in a posture protruded forwardly from the front face 42a of the guiding part 42.

Furthermore, at lower ends of the left and right side faces 42b of the guiding part 42, apertures 51 (refer to FIG. 4) are formed. In the apertures 51, stoppers 53 constituting the locking mechanism 40 are supported so as to be capable of advancing and retracting in a direction crossing a turning direction of the duplex conveying unit 5. The stopper 53 will be described later.

Next, the intermediate conveying unit 6 will be described. The intermediate conveying unit 6 has a height of the order of approximately half of the duplex conveying unit 5 and includes a front plate 57, a rear plate 58 and left and right side plates 59 as shown in FIG. 4. On the front plate 57, a plurality of ribs along the upward and downward directions are formed and, between the front plate 57 and the apparatus main body 2, the main conveying path 30 is arranged. In addition, on the front plate 57, as described above, one roller 37a of the pair of resist rollers 37 and the secondary transferring roller 25 are disposed at a predetermined interval along a conveyance direction. On the rear plate 58 as well, a plurality of ribs along the upward and downward directions are formed and, between the rear plate 58 and the front face 42a of the guiding part 42 of the duplex conveying unit 5, the duplex conveying path 32 is arranged.

On the left and right side plates 59, left and right arm pieces 60 protruding diagonally backward and downward from their lower edges are extended. At lower ends of the respective left and right arm pieces 60, pivoting parts 61 are coaxially formed. Each pivoting part 61 is pivoted to each supporting shaft 46 of the duplex conveying unit 5. In this manner, the intermediate conveying unit 6 turns around the supporting shafts 46 of the duplex conveying unit 5 between the closed position when the main conveying path 30 is arranged between the intermediate conveying unit 6 and the apparatus main body 2 and the open position when the main conveying path 30 is opened.

In addition, on the left and right side plates 9, locking levers 62 interlocking with the opening and closing levers 48 of the duplex conveying unit 5 are supported. Each locking lever 62 is formed in an L-shape as viewed from the lateral side, a distal end thereof is disposed so as to face to the opening and closing lever 48 from a lower side and a proximal end thereof is rotatably supported at a lower side of the secondary transferring roller 25. Moreover, to both ends of a rotating shaft 25a of the secondary transferring roller 25 are rotatably coupled to linking members 63 and linking members 63 are rotatably coupled in the vicinity of the centers of the locking levers 62.

Further, on the left and right side plates 59, at an upper side of the left and right arm pieces 60, longitudinally elongated apertures 65 as depressions constituting the locking mechanism 40 together with the stoppers 53 as mentioned above are formed. Each aperture 65 is formed on a turning trajectory of each stopper 53 when the intermediate conveying unit 6 is turned around the supporting shafts 46. In addition, on the front side (a rear side) from the apertures 65 in a direction of the intermediate conveying unit 6 approaching the duplex conveying unit 5, pressing faces 66 as an abutment part constituting the locking mechanism 40 are formed. Each pressing face 66 is formed so as to incline in an outside direction along the approaching direction.

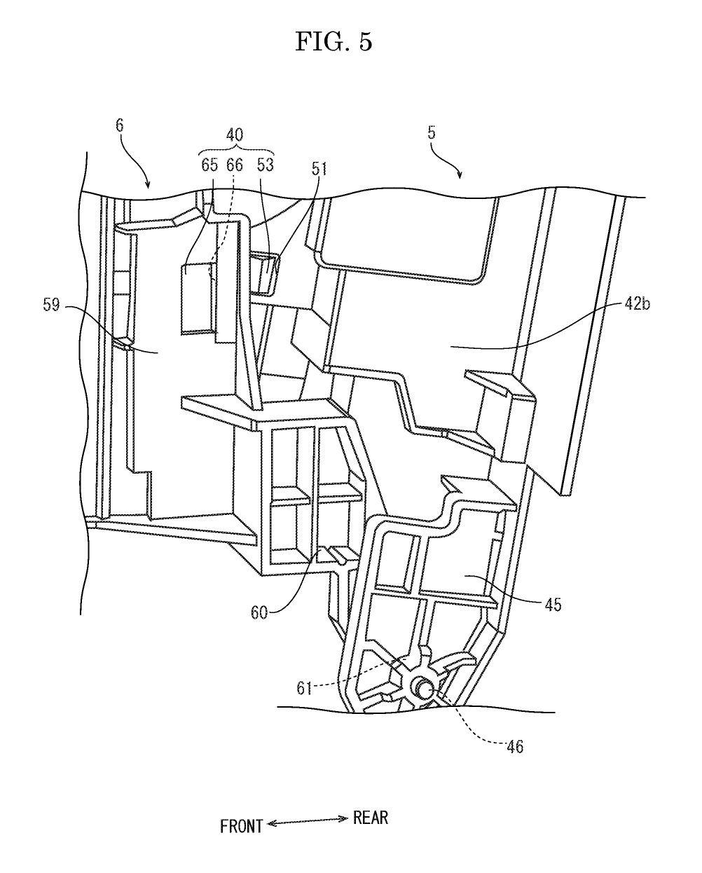

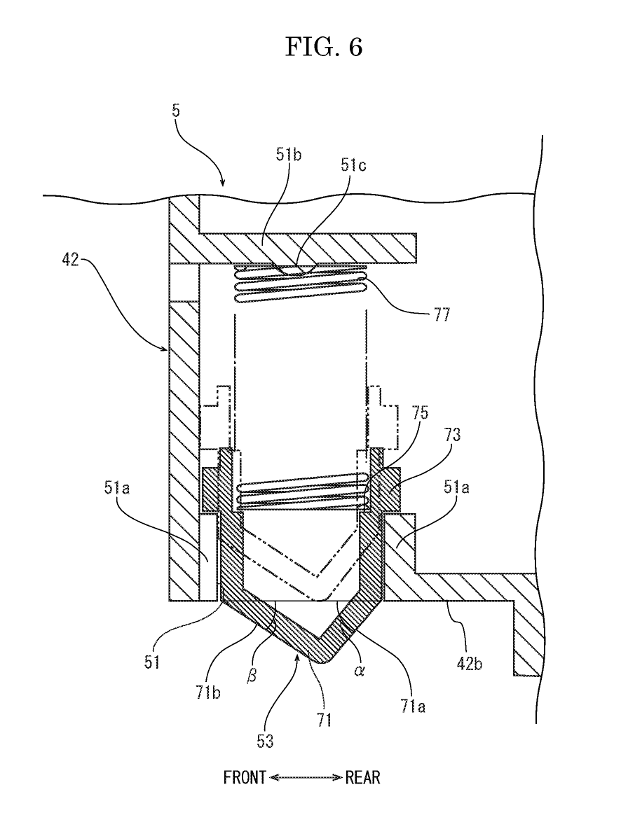

Next, with reference to FIG. 5 and FIG. 6, the locking mechanism 40 will be described. FIG. 5 is a perspective view showing the locking mechanism and FIG. 6 is a transverse sectional view of the stopper. As shown in FIG. 5, the locking mechanism 40 is composed of the stoppers 53 supported in the apertures 51 formed in the left and right side faces 42b of the guiding part 42 of the duplex conveying unit 5 and the apertures 65 and the pressing faces 66 formed in the left and right side plates of the intermediate conveying unit 6, as described above.

With reference to FIG. 6, each stopper 53 will be described. The aperture 51 supporting the stopper 53 is formed in a rectangular shape and, at front and rear edges of the aperture 51, guiding walls 51a extending to the inside are formed. Also, inside of the aperture 51, a supporting wall 51b facing to the aperture 51 is formed and, on the supporting wall 51b, a boss 51c is erected so as to face to the aperture 51.

The stopper 53 is a hollow-shaped member having an opened rear end face and having a distal end 71 formed in a triangular shape in a planar view. The distal end 71 has a depth side inclined face 71a on the depth side (a rear side) and a near side inclined face 71b on the near side (a front side) in a direction of the duplex conveying unit 5 approaching the intermediate conveying unit 6. Here, an inclination angle α of the depth side inclined face 71a with respect to the approaching direction is set greater than an inclination angle β of the near side inclined face 71b with respect to the approaching direction.

On a side face of the stopper 53, a flange 73 overhanging in the outside direction is formed along the outer circumference. Also, in a hollow part of the stopper 53, a stepped part 75 is formed between a large diameter part at the rear end side and a small diameter part at the distal end side.

The stopper 53 is disposed between guiding walls 51a inside of the aperture 51 and the distal end 71 is biased by a coil spring 77 so as to protrude from the aperture 51. In the coil spring 77, a distal end thereof is engagingly locked with the stepped part 75 of the hollow part and a rear end thereof is engagingly locked with the boss 51c of the supporting wall 51b. The stopper 53 is biased by the coil spring 77, and then, until the flange 73 is engagingly locked with an end face of the guiding wall 51a, the distal end 71 is guided along a space between guiding walls 51a and advanced in the outside direction from the aperture 51. On the other hand, if the distal end 71 is pushed into the aperture 51 against a biasing force of the coil spring 77, as indicated by a two-dot chain line in FIG. 6, the stopper 53 is retracted in the aperture 51.

In the color printer 1 having the above-described configuration, the duplex conveying unit 5 and the intermediate conveying unit 6 are coupled to each other by the locking mechanism 40. That is, the stopper 53 of the duplex conveying unit 5 is biased by the coil spring 77 and the distal end 71 is advanced and fitted into the aperture 65 of the intermediate conveying unit 6, and thereby, both units 5 and 6 are coupled to each other. Incidentally, in the stopper 53, a portion at a rear end side from the distal end 71 is advanced into the aperture 65. In addition, the rotating shaft 25a of the secondary transferring roller 25 is engaged with an engaging part (not shown) formed in the apparatus main body 2 so that the secondary transferring roller 25 faces to the intermediate transferring belt 14 (refer to FIG. 1). Since the rotating shaft 25a of the secondary transferring roller 25 is thus engaged with the apparatus main body 2, the intermediate conveying unit 6 is maintained at the closed position and the main conveying path 30 is arranged. Moreover, the duplex conveying unit 5 coupling to the intermediate conveying unit 6 is also maintained at the closed position and the duplex conveying path 32 is arranged.

In a case where a sheet jam occurs in the main conveying path 30, the duplex conveying unit 5 and the intermediate conveying unit 6 coupled to each other are integrally turned. At this time, if the opening and closing levers 48 are turned downwardly, the locking levers 62 are pushed downwardly by the opening and closing levers 48 and turned downwardly around the supporting shafts. Accordingly, via the linking members 63 coupling to the locking levers 62, the turning shaft 25a of the secondary transferring roller 25 is moved and decoupled from the engaging part of the apparatus main body 2. In this manner, the intermediate conveying unit 6 becomes turnable with respect to the apparatus main body 2 and the main conveying path 30 is opened.

In a case where a sheet jam occurs in the duplex conveying path 32, in a state in which the duplex conveying unit 5 and the intermediate conveying unit 6 are turned, both units 5 and 6 are turned in the separating direction from each other.

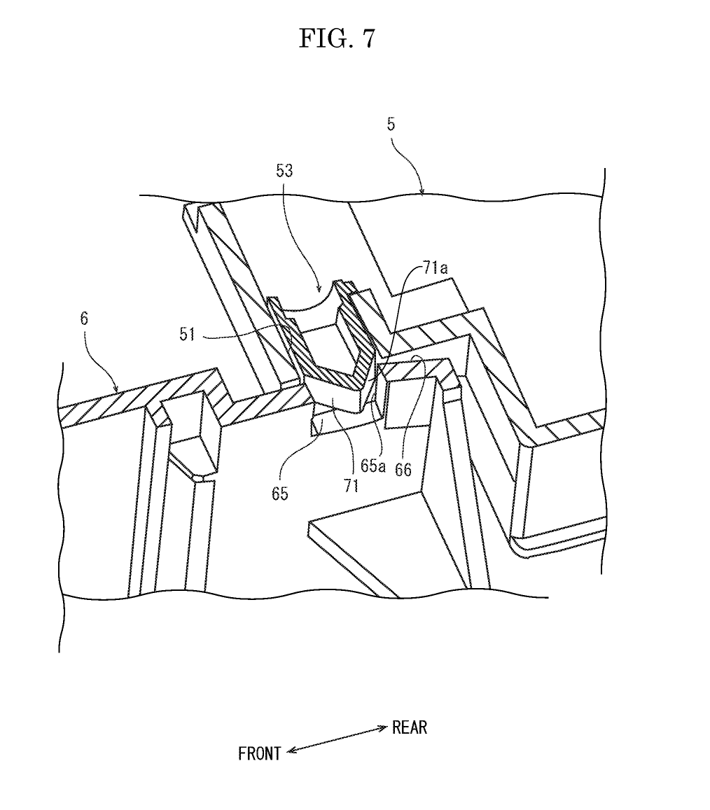

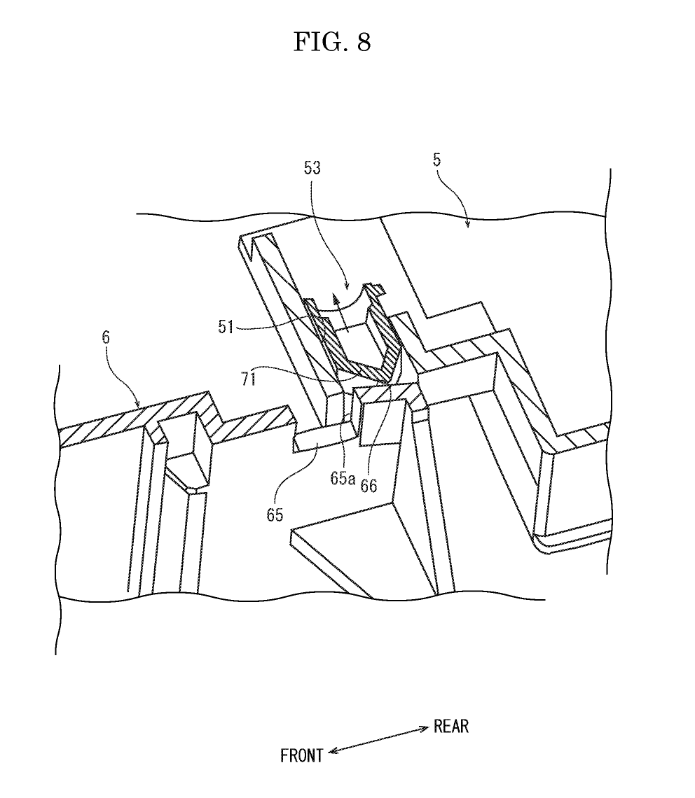

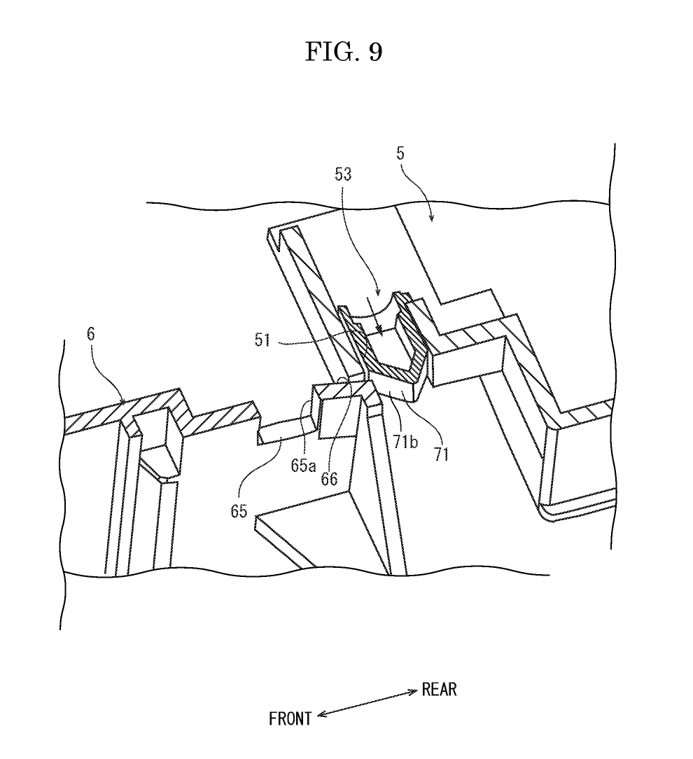

Accordingly, in the locking mechanism 40, as shown in FIG. 7 to FIG. 9, the intermediate conveying unit 6 and the duplex conveying unit 5 are decoupled from each other. FIG. 7 to FIG. 9 are perspective views usable to describe engaging and disengaging states of the locking mechanism, where FIG. 7 shows a state that the stopper is fitted into the aperture, FIG. 8 shows a state that the stopper is pressed by the inclined face and retracted and FIG. 9 shows a state that the stopper is completely separated from the aperture. Incidentally, in FIG. 7 to FIG. 9, the coil spring is not shown.

As shown in FIG. 7, at the time of coupling of both units 5 and 6 to each other, the stopper 53 is biased by the coil spring 77 and the distal end 71 is advanced and fitted into the aperture 65 and both units 5 and 6 are coupled to each other.

If the intermediate conveying unit 6 is turned in the separating direction from the duplex conveying unit 5, the pressing face 66 of the intermediate conveying unit 6 abuts against the depth side inclined face 71a of the distal end 71 of the stopper 53 to press the depth side inclined face 71a in an inside direction and the stopper 53 is retracted between the guiding walls 51a against the biasing force of the coil spring 77. Here, the pressing face 66 includes an edge 65a at the rear side of the aperture 65. Then, the distal end 71 is separated from the aperture 65 and, as shown in FIG. 8, an apex of the distal end 71 abuts against the pressing face 66. In this manner, the intermediate conveying unit 6 and the duplex conveying unit 5 are decoupled from each other and the duplex conveying path 32 becomes openable. While the distal end 71 is pressed against the pressing face 66, the stopper 53 is retracted. If the pressing face 66 is completely separated from the aperture 51, as shown in FIG. 9, the stopper 53 is biased by the coil spring 77, and then, the distal end 71 is advanced from the aperture 51.

After dealing with the sheet jam in the duplex conveying path 32 has completed, if the intermediate conveying unit 6 is turned in the approaching direction to the duplex conveying unit 5, in the locking mechanism 40, the pressing face 66 abuts against the near side inclined face 71b at the distal end 71 of the stopper 53 to presses the stopper 53 in the inside direction, and then, the stopper 53 is retracted between the guiding walls 51a against the biasing force of the coil spring 77 (refer to FIG. 8). Further, if the intermediate conveying unit 6 is turned, the distal end 71 of the stopper 53 reaches the aperture 65 from the pressing face 66, the stopper 53 is biased by the coil spring 77 and advanced, and then, the distal end 71 is fitted into the aperture 65 (refer to FIG. 7). In this manner, the intermediate conveying unit 6 and the duplex conveying unit 5 are coupled to each other.

Incidentally, the distal end 71 is formed so that the inclination angle α of the depth side inclined face 71a is set greater than the inclination angle β of the near side inclined face 71b. Therefore, a force of the pressing face 66 pressing the depth side inclined face 71a when the duplex conveying unit 5 and the intermediate conveying unit 6 are turned in the separating direction from each other, namely, when both units 5 and 6 are decoupled from each other, is greater than a force of the pressing face 66 pressing the near side inclined face 71b when the duplex conveying unit 5 and the intermediate conveying unit 6 are turned in the approaching direction to each other, namely, when both units 5 and 6 are coupled to each other.

After the intermediate conveying unit 6 and the duplex conveying unit 5 have been thus coupled to each other, both units 5 and 6 are turned to the closed position, the rotating shaft 25a of the secondary roller 25 is engaged with the engaging part of the apparatus main body 2, and thereby, both units 5 and 6 are maintained at the closed position.

As described above, in the color printer 1 of the present disclosure, the intermediate conveying unit 6 and the duplex conveying unit 5 are coupled to each other to become integrally turnable by turning both units in the approaching direction to each other and decoupled from each other merely by the work of turning both units in the separating direction from each other. Therefore, it is possible to easily open the main conveying path 30 and the duplex conveying path 32 and to easily carry out the work of dealing with the sheet jam.

In addition, since the locking mechanism 40 is a simple configuration fitting the stopper 53 into the aperture 65, it is possible to simplify the configuration of both units 5 and 6. Further, in the locking mechanism 40, a force of retracting the stopper 53 when the intermediate conveying unit 6 and the duplex conveying unit 5 are decoupled from each other is greater than a force of retracting the stopper 53 when the intermediate conveying unit 6 and the duplex conveying unit 5 are coupled to each other. Namely, since both units 5 and 6 are hardly decoupled from each other, when both units 5 and 6 are integrally turned, these units are not needlessly decoupled from each other. On the other hand, both units 5 and 6 can be coupled to each other with a comparatively small force. Also, since the locking mechanism 40 is formed at a position comparatively close to the supporting shaft 46, even if a turning angle of the intermediate conveying unit 6 with respect to the duplex conveying unit 5 is small, both units can be decoupled. That is, by slightly turning the intermediate conveying unit 6 with respect to the duplex conveying unit 5, it is possible to decouple both units.

In addition, since the intermediate conveying unit 6 and the duplex conveying unit 5 are turned around the same supporting shaft 46, it is possible to broaden a range of turning of both units 5 and 6 and to easily carry out the work of dealing with the sheet jam. Moreover, it is possible to downsize the color printer 1. Incidentally, the intermediate conveying unit 6 and the duplex conveying unit 5 may be configured so as to be turnable around different supporting shafts.

Further, by engaging the rotating shaft 25a of the secondary transferring roller 25 supported on the intermediate conveying unit 6 with the apparatus main body 2, the intermediate conveying unit 6 is engagingly locked at the closed position and the main conveying path 30 is arranged. In this manner, it is possible to enhance transferring accuracy in a case where the secondary transferring roller 25 transfers the toner image onto the sheet conveyed along the main conveying path 30. Furthermore, by operation of the opening and closing levers 48, the rotating shaft 25a of the secondary transferring roller 25 can be engaged with and disengaged from the apparatus main body 2 via the locking levers 62 and the linking members 63. In this manner, by way of a simple mechanism, positioning of the secondary transferring roller 25 with respect to the intermediate conveying transferring belt 14 and arranging of the main conveying path 30 by engagingly locking the intermediate conveying unit 6 with the apparatus main body 2 can be achieved.

In the above-mentioned embodiment, an example of supporting the stopper 53 on the duplex conveying unit 5 and forming the aperture 65 and the pressing face 66 on the intermediate conveying unit 6 was described. However, another embodiment may be configured so that the stopper 53 is supported on the intermediate conveying unit 6 and the aperture 65 and the pressing face 66 are formed on the duplex conveying unit 5.

Further, the above-description of the embodiments was described about one example of the image forming apparatus including this according to the present disclosure. However, the technical scope of the present disclosure is not limited to the embodiments. Components in the embodiment described above can be appropriately exchanged with existing components, and various variations including combinations with other existing components are possible. The description of the embodiment described above does not limit the content of the disclosure described in the claims.

What is claimed is:

1. An image forming apparatus comprising:
a duplex conveying unit provided in an aperture of an apparatus main body to be turnable around a lower end thereof;
an intermediate conveying unit disposed inside the duplex conveying unit and provided to be turnable around a lower end thereof;
a duplex conveying path arranged between the duplex conveying unit and the intermediate conveying unit;
a main conveying path arranged inside the intermediate conveying unit; and
a locking mechanism coupling the duplex conveying unit and the intermediate conveying unit to each other by turning the duplex conveying unit and the intermediate conveying unit in an approaching direction to each other and decoupling the duplex conveying unit and the intermediate conveying unit from each other by turning the duplex conveying unit and the intermediate conveying unit in a separating direction from each other.

2. The image forming apparatus according to claim 1, wherein
the locking mechanism includes:
a stopper provided in one unit of the duplex conveying unit and the intermediate transferring unit so as to be capable of advancing and retracting in a direction crossing a turning direction of the duplex conveying unit and the intermediate transferring unit and biased in advancing and retracting directions; and
a depression and an abutment part provided in another unit of the duplex conveying unit and the intermediate transferring unit so that the abutment part is provided at a near side from the depression in the approaching direction to be capable of pressing the stopper in the retracting direction,
if the duplex conveying unit and the intermediate conveying unit are turned in the approaching direction to each other, the stopper is pressed and retracted by the abutment part, and then, advanced and fitted into the depression so as to couple the duplex conveying unit and the intermediate conveying unit to each other,
if the duplex conveying unit and the intermediate conveying unit are turned in the separating direction from each other, the stopper is pressed by the abutment part, and then, retracted from the depression so as to decouple the duplex conveying unit and the intermediate conveying unit from each other.

3. The image forming apparatus according to claim 2, wherein
the stopper has a distal end capable of being fitted into the depression,
the distal end is formed in a triangular shape in a planar view having inclined faces at a near side and a depth side in the approaching direction, and an inclination angle of the inclined face at depth side with respect to the approaching direction is set greater than an inclination angle of the inclined face at the near side with respect to the approaching direction.

4. The image forming apparatus according to claim 1, wherein
the duplex conveying unit and the intermediate conveying unit are turned around a same supporting shaft.

5. The image forming apparatus according to claim 1, further comprising:
a transferring roller rotatably supported on the intermediate conveying unit to transfer a toner image formed on an image carrier onto a sheet,
wherein when a rotating shaft of the transferring roller is engaged with the apparatus main body, the transferring roller is positioned with respect to the image carrier and the intermediate conveying unit is engagingly locked with the apparatus main body, and thereby, the main conveying path is arranged.

6. The image forming apparatus according to claim 5, wherein
the duplex conveying unit includes:
an opening and closing lever configured to be operated when the duplex conveying unit is turned,
the intermediate conveying unit includes:
a locking lever turning by interlocking with operation of the opening and closing lever; and
a linking member having one end coupled to the rotating shaft of the transferring roller and another end coupled to the locking lever,
by operation of the opening and closing lever, the rotating shaft of the transferring roller is engaged with or disengaged from the apparatus main body via the locking lever and the linking member.

7. The image forming apparatus according to claim 2, wherein
the stopper is provided on each of left and right side faces of one unit of the duplex conveying unit and the intermediate transferring unit,
the depression and the abutment part are provided on each of left and right side faces of another unit of the duplex conveying unit and the intermediate transferring unit.

8. The image forming apparatus according to claim 2, wherein
the locking mechanism includes:
a coil spring applying a biasing force in the advancing direction to the stopper.

9. The image forming apparatus according to claim 4, wherein
the locking mechanism is formed at a position close to the supporting shaft.
